(19) United States
(12) Patent Application Publication
(10) Pub. No.: US 2005/0225172 A1
(43) Pub. Date: Oct. 13, 2005

(54) Open web trimmable truss with self locking joint

(76) Inventor: Lionel Brightwell, Boise, ID (US)

Correspondence Address: WEYERHAEUSER COMPANY;INTELLECTUAL PROPERTY DEPT., CH 1J27, P.O. BOX 9777, FEDERAL WAY, WA, 98063, US

(21) Appl. No.: 10/823,037

(22) Filed: Apr. 12, 2004

(51) Int. Cl. B60B 19/02

(52) U.S. Cl. 305/107

(57) ABSTRACT

A wood containing, open web trimmable truss assembly composed of opposed chord members defining an open web central structure that is bounded at each ends by a closed, trimmable end block. The open web central structure is formed by a plurality of web elements attached to the chord members via a mortise and tenon coupling. The trimmable end block is attached to both chord members and the outer most web element.

### FIELD OF THE INVENTION

This invention relates broadly to the art of truss and joist construction. More particularly the invention relates to trusses which combine the benefits of open web truss construction with closed web joist construction, there by providing construction site variable length adjustment while conserving the factory built structural integrity.

### BACKGROUND OF THE INVENTION

Current truss designs envision a variety of broad design types, but they generally fall into two broad categories, open or closed web design. Both current designs have their problems.

The closed truss is the most common variable length truss. Closed truss designs suffer from several construction problems. First, the design requires a great deal more material, having a closed volume. Second, the design has difficulty with respect to the passage of ducting, plumbing, wiring, etc. within the area defined by the interior of the truss since it is solid and must be cut. This provides for two problems. First, the strength of the truss may be affected by the cutting. Second, a great deal of time and equipment may be necessary in order to manufacture this space for utility passage. Other related problems may exist as a result of these general problems including the need for engineering analysis to determine where holes may be located and where web reinforcements are required.

Two by ten or two by twelve joists made of solid wood are also very common. A major problems associated with these are that they require old growth timber to provide large enough lumber. In addition, when oriented edgewise, they provide an inferior nailing surface compared with that provided by truss chords oriented flatwise. This is particularly important when adding subfloors and ceilings to the joists since only an approximate location of the supporting member can be found. In addition, span lengths are greatly diminished by the load carrying properties of these timbers.

A variety of open web truss designs are known. However, design of most open web trusses requires the use of metal due to structural requirements of the truss. The use of a large number of metal and wood components increases the complexity of truss component alignment and assembly as well as increases costs. Additionally, typical open web truss designs require that the manufactured length of the truss closely match the as-built span of the building because the truss configuration (and metal truss components in particular) makes field length adjustment or trimming nearly impossible.

There are a number of hybrids that combine the features of open web truss center configuration with closed web trimmable end configuration. The products typically exhibit a degree of structural deficiency in completing the transition between solid web joist end and open web truss center. The transitioning problem is caused because the joist end behaves structurally like a beam and resists imposed loads with bending member stresses, whereas the truss center behaves structurally like a truss and resists imposed loads with axial member stresses. The most common limitations of this difficult transition is a requirement that the trusses be installed with a certain designated side up, or trim is limited to a small amount and perhaps requiring that both ends be trimmed equally.

### SUMMARY OF THE INVENTION

The described structure provides a lightweight, yet strong open web trimmable truss formed from a wood containing material. The truss assembly includes a pair of chord members. The chord members each include a mortise and a trimmable end block groove. A web element extends between the chord members. Tenons disposed on opposite ends of the web element engage with said mortise. The outer most web elements in the truss assembly also include a web element groove. Additionally, the trimmable truss includes a trimmable end block. The trimmable end block has opposed trimmable end block chord edges that engage the chord members via trimmable end block groove. The trimmable end block also has a web element edge that engages the web element groove. Generally, the truss assembly is constructed from a wood containing material.

The trimmable truss assembly also includes a self locking joint. The self locking joint is formed by the interaction of a mortise and a pair of “mated” web element tenons. A first web element includes tenons formed by a first tenon seat cut and a first tenon square cut. Further, a second web element includes a second tenon defined by a second tenon seat cut and a second tenon square cut. When mated, the first tenon is adjacent the second tenon and both are within the mortise. The mortise may be either a single taper mortise or a double taper mortise.

### BRIEF DESCRIPTION OF THE DRAWINGS

The preferred and alternative embodiments of the present invention are described in detail below with reference to the following drawings.

FIG. 1 is an exploded isometric view of an open web trimmable truss according to the present invention;

FIG. 2 is a side view of the open web trimmable truss illustrated in FIG. 1;

FIG. 3 is a end view of the open web trimmable truss illustrated in FIG. 2;

FIG. 4 is a side, partial sectional view of a chord member of the truss assembly of the present invention;

FIG. 5 is a side view of a trimmable end block according to the present invention;

FIG. 6 is a side view of a web member according to certain aspects of the present invention;

FIG. 7 is an isometric view of the outermost web member according to certain aspects of the present invention;

FIG. 8 an exploded isometric view of and aspect of the open web trimmable truss according to the present invention;;

FIG. 9 is a top view of a section of chord member with a double taper mortise according to certain aspects of the present invention;

FIG. 10 is a bottom view of a pair of web members according to certain aspects of the present invention;

FIG. 11 is a isometric view of a mated pair of mated web members according to certain aspects of the present invention;

FIG. 12 is an isometric of a web member according to certain aspects of the present invention;

FIG. 13 is an isometric view of a mated pair of mated web members according to certain aspects of the present invention;

FIG. 14 is a top view of a pair of web members and chord member according to certain aspects of the present invention;

FIG. 15 is a top view of a section of chord member with a single taper mortise according to certain aspects of the present invention;

FIG. 16 is a bottom view of a pair of web members according to certain aspects of the present invention;

FIG. 17 is an isometric view of a mated pair of mated web members according to certain aspects of the present invention; and

FIG. 18 is a side elevation view showing a variety of sized trimmable trusses made in accordance with the present invention.

### DETAILED DESCRIPTION OF THE INVENTION

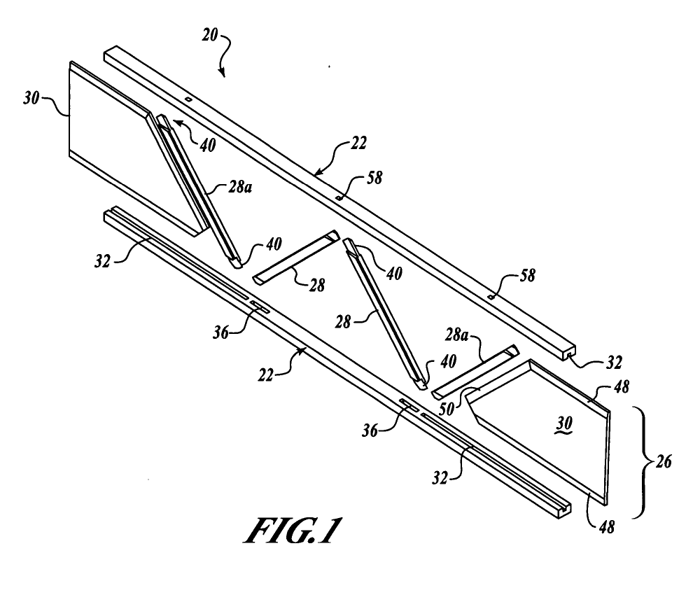

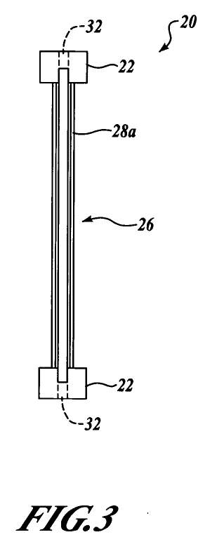

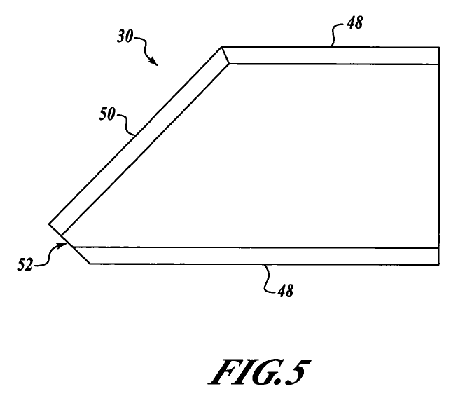

The present invention provides an open web trimmable truss that utilizes a novel, self-centering and locking joint. By way of overview and with reference to FIGS. 1-4 and 6, an embodiment of the present invention includes chord members 22 and a web 26 integrally combined to form a trimmable truss 20. The web 26 includes two distinct regions, a solid region on both ends of the trimmable truss 20 and an open region positioned between the solid regions. The solid region is generally indicated by trimmable end block 30 and the open region indicated by the region of the trimmable truss 20 incorporating web elements 28. The chord members 22, trimmable end blocks 30 and web elements 28 are all integrally connected to form a lightweight and strong trimmable truss 20. The trimmable truss 20 typically has an I-beam cross-sectional shape. Specific details of the trimmable truss 20 are described with more particularity below.

The trimmable truss 20 is constructed from various wood containing materials. A suitable example of the type of wood containing material the chord members 22 and web elements 28 are constructed from laminated strand lumber such as TimberStrand® sold by Weyerhaeuser Company. The trimmable end block 30 may be any known engineered panel, such as, without limitation, plywood or oriented strand board. It will be appreciated however that other materials may be used without parting from the spirit and scope of the present invention.

Chord members 22 include two types of cutouts. A mortise 36 is configured to receive an interlocking pair of tenons 40, described in more detail below. The mortise 36 may or may not include a bore 58 extending through the chord member 22. Additionally, the chord member 22 includes a trimmable end block groove 32 configured to receive a trimmable end block chord edge 48 of the trimmable end block 30. Those skilled in the art will appreciate that the trimmable end block groove 32 may be a tapered groove if the trimmable end block edge 48 is beveled. Likewise, if the trimmable end block edge 48 is not beveled, the trimmable end block groove 32 may be untapered. With regards to the trimmable truss 20, both chord members 22 contain the same cutouts. As formed, the spacing of one chord member 22 is laterally offset from the other to facilitate formation of the trimmable truss 22.

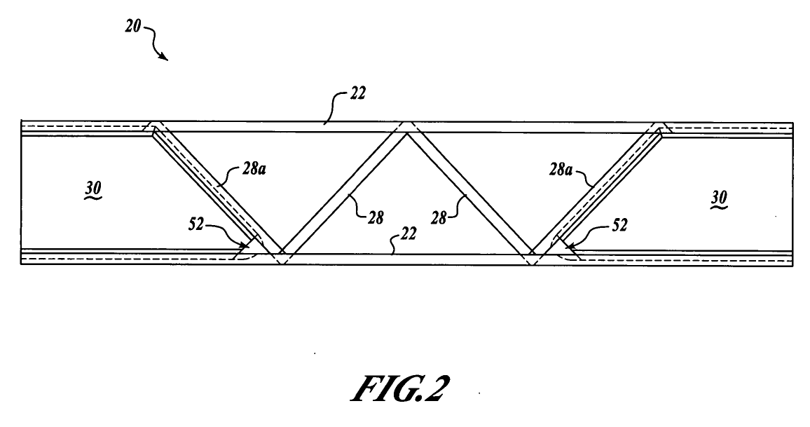

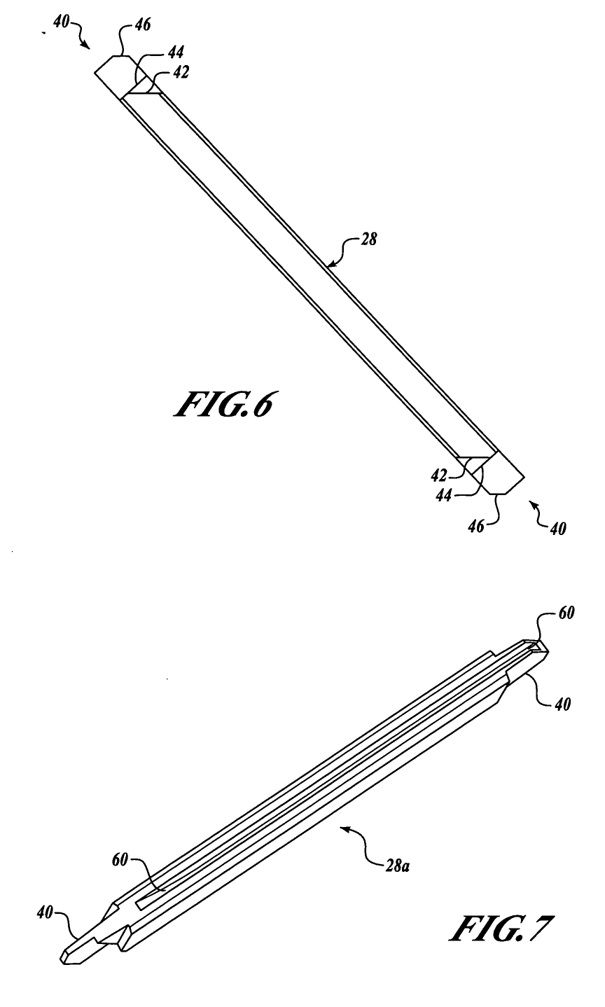

As best seen in FIGS. 2, 5 and 7, the tenons 40 of the web elements 28 mate and engage the mortise 36. Likewise, the trimmable end block edge 48 of the trimmable end block 30 engages the trimmable end block groove 32. Additionally, a trimmable end block web element edge 50 of the trimmable end block 30 is formed at an angle to match the angle of the outer most web element 28a. The outer most web element 28a includes a web element groove 60 matched to receive the trimmable end block web element edge 50.

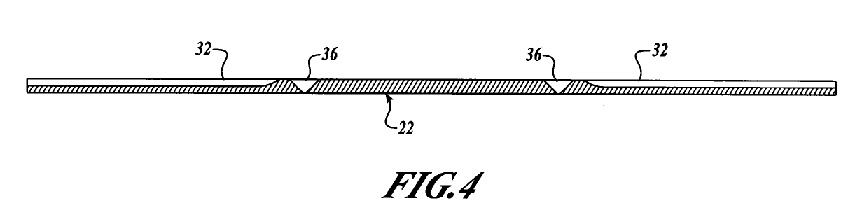

As best seen in FIGS. 2 and 5, the trimmable end block 30 includes an end block notch 52. The end block notch 52 is positioned a distance from an intersection point between a main axis of the trimmable end block chord edge 48 and the trimmable end block web element edge 50. The end block notch 52 is located a sufficient distance from the intersection to allow positive engagement of the chord member 22, outer most web element 28a and trimmable end block 30. As the end block notch 52 makes the length of the trimmable end block web element edge 50 shorter than the length of the outer most web element 28a, it is not necessary for the web element groove 60 to extend the entire length of the web element 28a.

FIG. 8 depicts one aspect of the behavior of truss 20 under load. Specifically, The FIGURE depicts the reactions to loading within the web element 28, outer most web element 28a, trimmable end block 30, and chord members 22. The truss 20 is subjected to applied loads along the length of its span which produce an end reaction. Those skilled in the art will appreciate that the given loading illustrated will place the respective chord members 22 in tension or compression. The effect of the end reaction on the trimmable end block 30 is one of causing it to behave like a beam and rotate away from the reaction force. This “beam action” yields a glue line shear force between the trimmable web member chord edge 48 and the trimmable member groove 32.

A transition zone 49 is also present when the truss 20 is under loading. The transition zone 49 is that part of the truss 20 where the truss 20 switches from behaving like a beam to behaving like a truss 20. The transition zone 49, in general terms, refers to interaction between the trimmable end block web element edge 50 and the web element groove 60 of the outermost web element 28a.

Under loading illustrated, the truss 20 places the outer most web element 28a in tension as illustrated by resultant tension load R₂ and web member 28 under compression as illustrated by, opposite but equal, resultant tension load R₁. This resultant tension load R₂ gets transferred to the trimmable end block 30 via a tension shear between the trimmable end block web element edge 50 and the web element groove 60 of the outermost web element 28a.

It will be appreciated that truss 20 may be used with either chord member 22 on top. As such, the outer most web element 28a may be either in tension or compression, depending upon how the truss 20 is utilized. In either configuration, the tension or compression within the outer most web element 28a is transferred to the trimmable end block 30 as described above. Those skilled in the art, will appreciate that without this transfer zone 49, the loading in the outer most web element 28a would be carried into the chord member 22. The result of such an arrangement would lead to either the web element wanting to pull out of engagement with the chord member 22 or wanting to drive further into the chord member 22. Both of which are undesirable conditions in a truss 20.

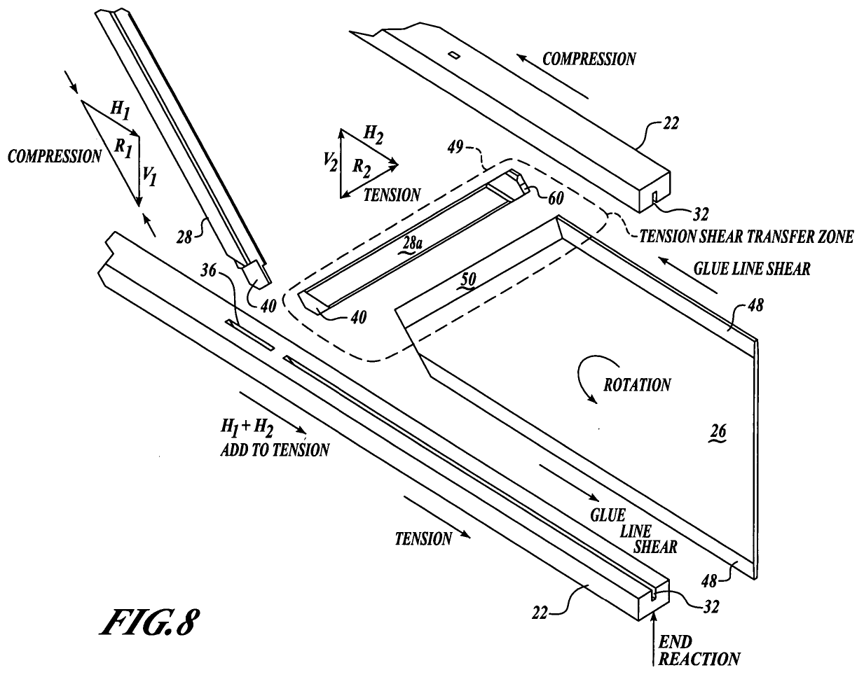

FIGS. 9-11 illustrate various features of an embodiment of the present invention. Specifically, FIG. 9 illustrates a double taper mortise 36a in chord member 22a. The term “double taper” is meant to indicate a mortise 36a tapered in two directions. The first taper direction is a centering taper 39. The direction of this taper is parallel to the main axis of the chord member 22a, or along the X axis as indicated in the FIGURE. The centering taper 39 is typically cut at about a 45 degree angle relative to a plane passing vertically into the plane of the paper along the Y-axis. However, a mortise 36a having a centering mortise 39 cut at an angle above or below 45 degrees is also considered within the scope of this invention.

In this embodiment, mortise 36a also includes a locking taper 37. The direction of this taper is perpendicular to the main axis of the chord member 22a, or along the Y-axis as indicated in the FIGURE. The locking taper 39 is typically cut at about a 5 degree angle relative to a plane passing vertically into the plane of the paper along the X-axis. However, a mortise 36a having a locking taper 37 cut at an angle above or below 5 degrees is also considered within the scope of this invention.

The locking taper 37 is configured to taper inwardly. As best seen in FIG. 9, the locking taper 37 has its widest spacing represented as M1 and its narrowest spacing as M2. The width of M1 is selected to be some width greater than the thickness of the mated tenons 41a as indicated as T1 in FIG. 11. However, the width of M2 is selected as being some width less than the thickness of the mated tenons 41a. In this manner, the locking taper 37 at M1 permits the mated tenons 41a to be easily inserted into the mortise 36a, while applying an increasing compression force to the mated tenons 41a as they approach M2. This increasing compression force is the self-locking feature for this embodiment. The relative sizing of M1, M2 and T1 are generally selected to create an interference fit of about 0.005 to about 0.035.

With respect to all embodiments and as discussed above, the web element 28 includes a tenon 40 at each end. For simplicity reasons only we will limit our description to a single tenon 40 with the understanding that discussion of one tenon 40 applies equally to all tenons 40 for a given embodiment. For all embodiments, one tenon's orientation on the web element 28 relative to the other tenon's orientation is best described as the tenon profile on opposite ends of a web member 28 are identical in profile but with opposing orientation. This orientation can be visualized as rotated 180 degrees in the plane of the trimmable truss 20 about the centroid of the finished web element 28.

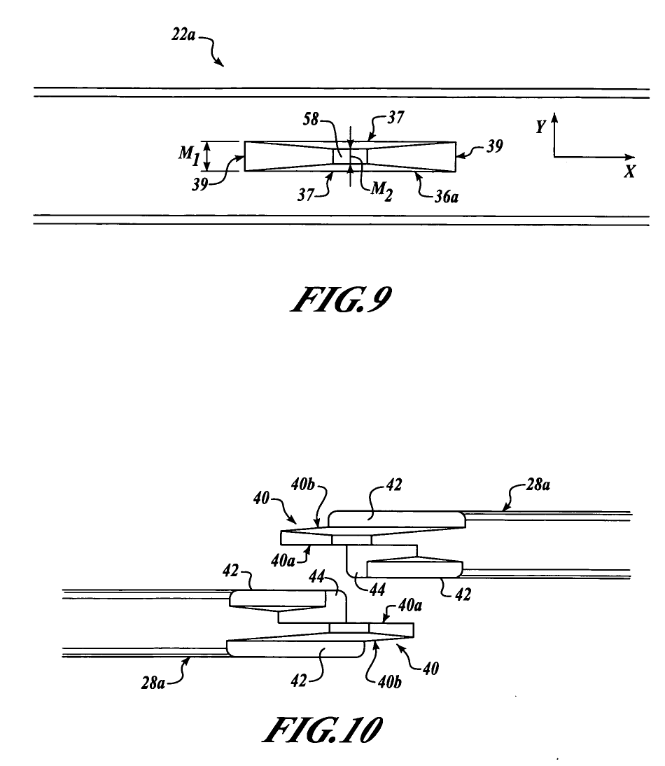

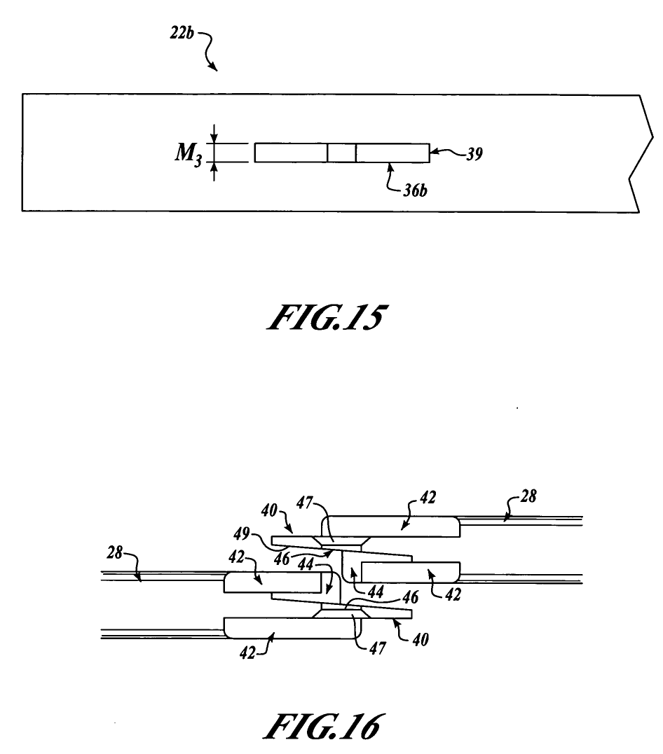

FIGS. 10-14 illustrate various features of web element 28 with respect the double taper mortise 36a embodiment. Tenon 40 is formed by two cuts, a seat cut 42 and a square cut 44. The seat cut 42 is formed by a pair of angled cuts, one cut on each side of the web element 28 per tenon 40. The angle is typically at about 45 degrees relative to the longitudinal axis of the web element 28. However, it will be appreciated that other geometries may be used when forming the seat cut 42. With the double taper mortise embodiment, the seat cut 42 is made such that the outer surface 40b of tenon 40 is beveled.

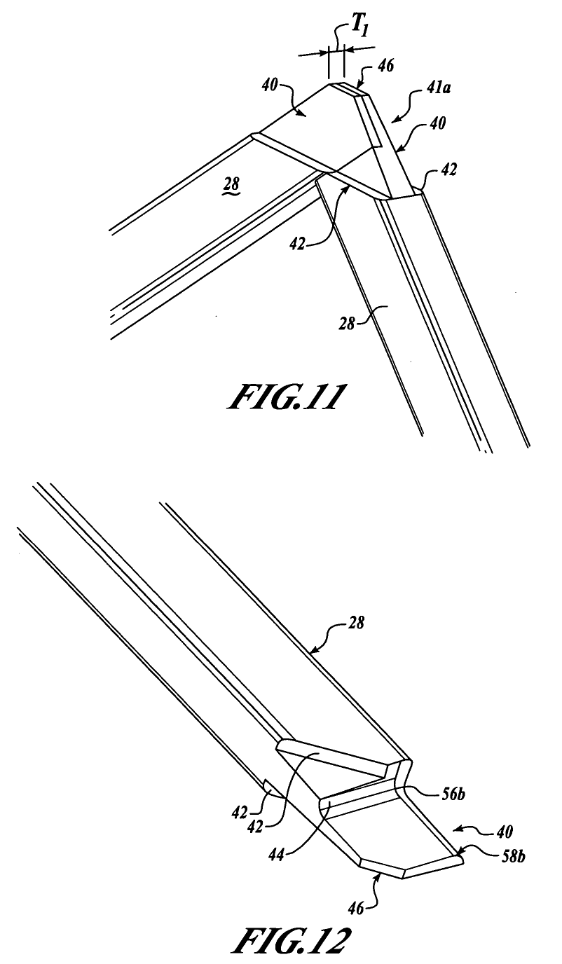

The square cut 44 is made at an angle of about 90 degrees relative to the longitudinal axis of the web element 28. The square cut 44 is only formed on a single side of the web element 28 per tenon 40. The square cut 44 may be made to form a substantially right angle tenon edge profile 56a. Conversely, the tenon edge profile 56b may be a rounded, or fillet type cut as depicted best in FIG. 12. Likewise, the back edge 58a,b may be left square or rounded over. Additionally, other edges may be rounded or the cuts configured to form fillet type corner edges. Those skilled in the art will appreciate that rounding or forming fillet type cuts helps to limit or relieve stress concentrations in the region of the cut or fillet. Thus, the overall strength of the tenon is maximized.

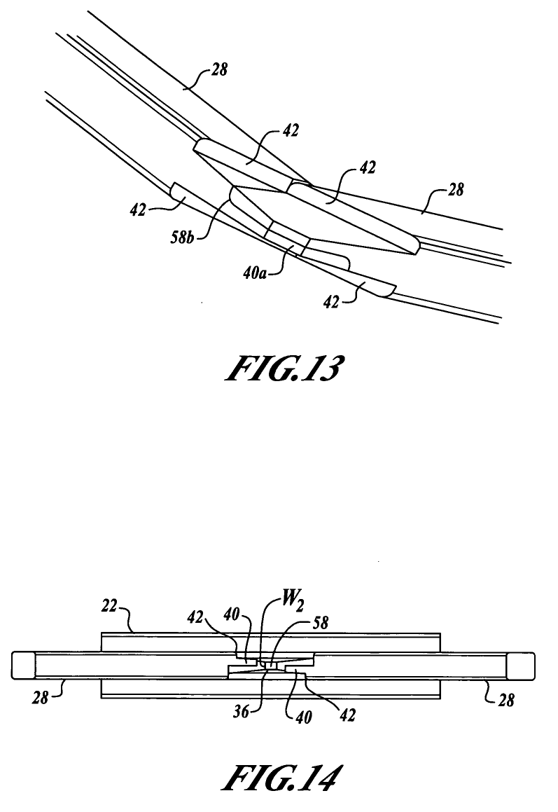

FIG. 11 illustrates the web elements 28 wherein the respective tenons 40 are mated, or otherwise configured as they would be when inserted into the double taper mortise 36a. As formed, the mated tenons 40 position the longitudinal axis of one web element 28 at about a 90 degree angle relative the longitudinal axis of the other web element. A nip 46 is present at the outer most point of the mated tenons 40. The nip 46 is generally arranged to prevent any section of the tenon from extending through bore 58 when the mated tenons 40 are inserted into the mortise 36a. FIG. 13 illustrates how the mated tenons would are configured when the tenons 40 include the rounding features discussed above and shown in FIG. 12.

FIGS. 15-17 illustrate an additional embodiment of the present invention. Specifically, this embodiment uses a single taper mortise 36b. The single taper mortise 36b embodiment includes a chord member 22b wherein the single taper mortise 36b includes only centering taper 39b. The centering taper 39b of this embodiment is formed in a similar fashion as the double taper mortise 36a. The centering taper 39b is generally formed with a taper about 45 degrees relative to a plane vertical with the page. Those skilled in the art will appreciate that other geometries are available for the centering taper 39b without departing from the spirit and scope of the invention.

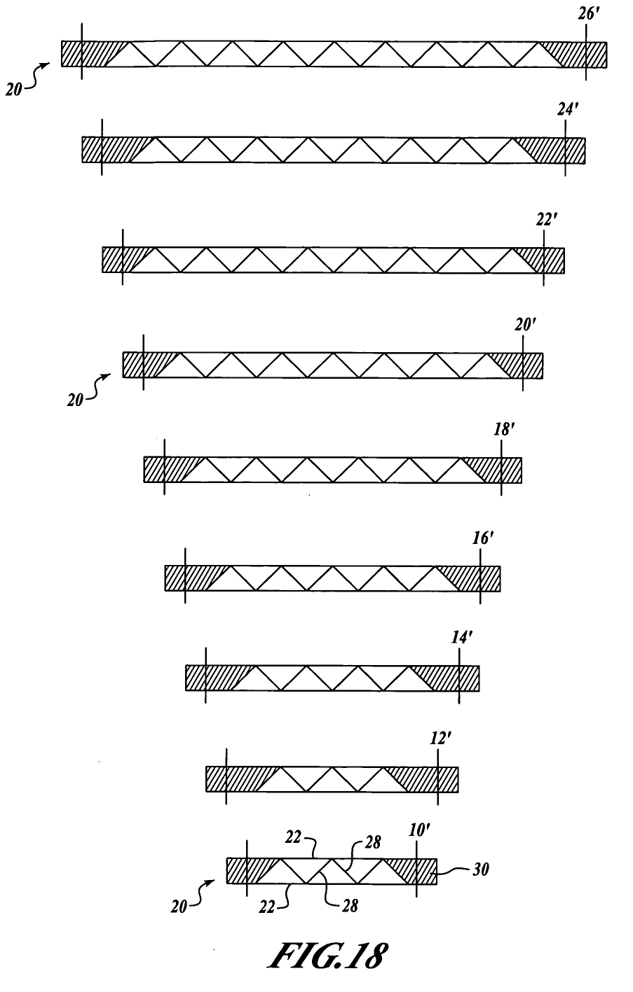

The width of the single taper mortise 36b is indicated as M3. With reference to FIGS. 15 and 17, M3 is only slightly less than the thickness of mated tenons 40 as indicated by T3. The relative sizing of M3 and T3 are generally selected to create a interference fit of about 0.005 to about 0.035. To increase the ease at which the mated tenons 40b are inserted into the single taper mortise 36b, the tenons include a nip bevel 47.

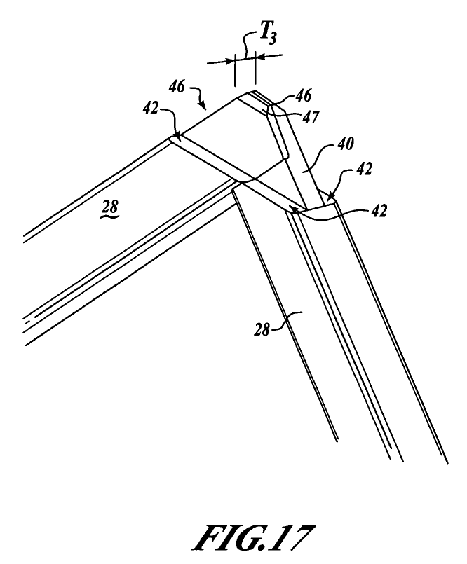

With specific reference to FIG. 16, the square cut 44 is typically made such that the mating surface 49 is beveled, or otherwise not parallel to the main axis of the web 28. However, the seat cut 42 is made such that the outer surface of tenon 40 is parallel to the main axis of the web 28.

FIG. 18 depicts a variety of trimmable trusses 20 of varying size. It will be appreciated that the trimmable nature of this truss design allows for a single trimmable truss 20 to be used in a variety of locations. Additionally, the adjustable length of the trimmable truss 20 compensates for inconsistencies in structural span during construction of a building.

When formed, the web elements 28, the trimmable end blocks 30 and the chord members 22 are additionally secured together by the application of an adhesive, such as a resin. The adhesive is typically an alkaline phenolic resin. However, other adhesives may be used, such as, without limitation, water-soluble and non-water-soluble alkaline and acidic phenolic resins, resorcinol-formaldehyde resins, urea-formaldehyde resins, isocyanate resins, melamine, and epoxy resin.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An open web trimmable truss assembly, comprising:
a pair of chord members, each chord member including a mortise and a trimmable end block groove;
a web element having a pair of opposed tenons, each tenon being engaged with mortise of one chord member, said web element further including a web element groove; and,
a trimmable end block integrally connected with said pair of chord members along said trimmable end block groove and said web element along said web element groove,
wherein said open web trimmable truss assembly is made of a wood containing material.

2. The truss assembly of claim 1, wherein said mortise is a single taper mortise, said single taper mortise being a centering taper.

3. The truss assembly of claim 2, wherein said centering taper is cut at an angle of about 45 degrees relative to a main axis of the chord member.

4. The truss assembly of claim 3, wherein the mortise and the tenon are sized to create an interference fit between the elements of about 0.005 to about 0.035 inches.

5. The truss assembly of claim 1, wherein said mortise is a double taper mortise, said double taper mortise including a centering taper and a locking taper.

6. The truss assembly of claim 4, wherein said centering taper is cut at an angle of about 45 degrees relative to a main axis of the chord member, and further wherein said locking taper is cut at an angle of about 5 degrees relative to a vertical plane along the main axis of the chord member.

7. The truss assembly of claim 6, wherein the mortise and the tenon are sized to create an interference fit between the elements of about 0.005 to about 0.035 inches.

8. The truss assembly of claim 1, wherein each of said opposed tenons are defined by a seat cut and a square cut, said seat cut and said square cut being formed at different angles relative to the web element major axis.

9. The truss assembly of claim 6, wherein said seat cut is about 45 degrees relative to a main axis of the web element.

10. The truss assembly of claim 6, wherein said square cut is about 90 degrees relative to a main axis of the web element.

11. The truss assembly of claim 1, wherein the wood containing material of the chord member and the web element is laminated strand lumber.

12. The truss assembly of claim 1, wherein the wood containing material of the trimmable end block is an oriented strand board.
